(19) United States
(12) Patent Application Publication
(10) Pub. No.: US 2003/0182204 A1
(43) Pub. Date: Sep. 25, 2003

(54) System for managing eletronic receipt according to eletronic commerce and method for managing thereof

(76) Inventor: Soo-Won Rhee, Seoul (KR)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/362,849

(22) PCT Filed: Mar. 20, 2001
(86) PCT No.: PCT/KR01/00439

(30) Foreign Application Priority Data
Aug. 28, 2000 (KR) 2000/50057

(51) Int. Cl. G06F 17/60

(52) U.S. Cl. 705/26

(57) ABSTRACT

The present invention relates to an electronic receipt issuing system and the method thereof, comprising the steps of: a sales server selling products by using an internet and discharging the products to a purchasing client by a material distribution enterprise produces an electric receipt including a settlement breadkdown information of products purchased by the purchasing client, generates, keeps and manages an account information by a one-to-one correspondence of the products settlement breakdown information to each account item; the purchassing client which purchases products from the sales server by using the internet transfers the payment information to the sales server to pay for the purchasing products, stores the electric receipt transmitted from the sales server, keeps and manages the products settlement breakdown information.

### BACKGROUND OF THE INVENTION

1. Technical Field

The present invention relates to a management system and method of an electronic receipt by an electronic commerce, and more particularly, to a management system and method of an electronic receipt by an electronic commerce in which when an electronic commerce is generated, a sales server issues the electronic receipt in real time, and a purchaser client edits and manages a product settlement breakdown information contained in the electronic receipt issued by the sales server, thereby allowing information management and effective use of electronic commerce. Further, this invention relates to a management system and method of an electronic receipt by an electronic commerce in which the sales server issues an electronic tax invoice based on the settlement breakdown information of a product by the electronic commerce between companies called “business-to-business” or “B2B”, thereby enhancing reliability and transparency of the electronic commerce.

2. Background Art

Conventionally, in order for a purchaser to purchase a desired product, the purchaser directly visits a store, searches the desired product, and meets the payment on the product. However, this purchase method has drawbacks in that since the purchaser should directly visit the store in order to compare amounts of the products prepared at various stores, a waste in time is caused, and it is difficult to purchase the product at the most cheap price.

Further, since the purchaser separately collects receipts on the purchased products, and directly manages them, there is a danger of loss, and it is difficult to confirm the settlement breakdown of the purchased products, for instance, product name, merchant name, etc.

Meanwhile, as the Internet communications are recently developed, Internet commerce market as a new market capable of saving transaction costs and overcoming time limit and space limit is increasingly activated.

When electronic commerce market is briefly reviewed, sales server manages a homepage on its website, and introduces in detail information such as products images or purchasing prices, and the purchaser client visits homepages of various stores, searches and orders a desired product, and meets the payment on the ordered product using a credit card, an electronic cash, or an electronic check.

Sales server requests an inquiry approval of the credit card provided for meeting the payment on the product to a payment intermediary institution, and the payment intermediary institution requests an inquiry and approval of the credit card to a financial institution (bank or credit card enterprise).

As an approval number on the inquiry approval request of the credit card is received, the sales server displays a message showing that this order transaction is normal, transmits the purchase breakdown and order breakdown of the product selected by the purchaser client to the product distributing company, and delivers the product and the transaction confirmation sheet to the purchaser client.

Thus, the purchaser client can confirm information of the product which the purchaser client wishes to purchase with ease within a short time, and can purchase the product at the most cheap price, thereby securing the shortening of the shopping time and the economy.

Then, the transaction confirmation sheet that is delivered to the purchaser client together with the product arrives after a few days elapse since the payment is met, and also there frequently occurs a case that the transaction confirmation sheet contains a deficient content. To this end, in most cases, the purchaser client cannot confirm a concrete transaction and payment breakdown in detail.

Further, when the purchaser client wishes to keep the settlement breakdown of the product, the purchaser client should sort out these transaction confirmation sheets separately.

### DISCLOSURE OF THE INVENTION

It is an object of the invention to allow a sales server to issue an electronic receipt containing settlement breakdown information of a product in real time, and allow a purchaser client to create and keep a household information which corresponds to the settlement breakdown information of the product one-to-one.

It is another object of the invention to allow a purchaser client an arithmetic function such that the purchaser client can edit a created household information if necessary.

It is a further object of the invention to allow a sales server to issue an electronic receipt containing settlement breakdown information of a product in real time, and allow a purchaser client to create and keep an account information which corresponds to the settlement breakdown information of the product one-to-one.

It is a still further another object of the invention to issue an electronic tax invoice in real time based on settlement breakdown information of a product by B2B.

Another objects of the invention will be more apparent from the detailed description of the present invention described later.

To accomplish the above objects, there is provided a management system of an electronic receipt. The system is applied to an electronic commerce system in which a plurality of purchaser clients, a sales server, a financial institution, an approval institution, and a product distributing company carry out an electronic commerce through an Internet network.

The sales server issues the electronic receipt containing the settlement breakdown information of the purchasing product, and compares the settlement breakdown information with an account item in one-to-one correspondence to create an account information, and keeps and manages the created account information. The purchaser clients transmit the payment information to the sales server, store the electronic receipt transmitted from the sales server, and keep and manage the settlement breakdown information of the product.

### BRIEF DESCRIPTION OF THE DRAWINGS

FIG. 1 is a schematic view of a management system of an electronic receipt in accordance with the invention;

FIG. 2 is a block diagram showing a sales server in the management system of the electronic receipt;

FIG. 3A is a view showing an example of the electronic receipt which is issued to a personal purchaser client, and FIG. 3B is a view showing an example of the electronic receipt which is issued to a enterprise purchaser client;

FIG. 4 is a block diagram showing one embodiment of the purchaser client in the management system of the electronic receipt;

FIG. 5 is a view showing an example of a picture for inputting a payment information of the purchaser client;

FIG. 6 is a view showing an example of a household information which is created by matching information of the electronic receipts in one-to-one correspondence;

FIG. 7 is a block diagram showing another embodiment of the purchaser client in the management system of the electronic receipt;

FIG. 8 is a flow chart showing a management sequence of the electronic receipt in the purchaser client shown in FIG. 4;

FIG. 9 is a flow chart showing a management sequence of the electronic receipt in the purchaser client shown in FIG. 7; and

FIG. 10 is a flow chart showing a management sequence of the electronic receipt in the sales server shown in FIG. 2.

### BEST MODE FOR CARRYING OUT THE INVENTION

Hereinafter, there are in detail described preferred embodiments in accordance with the present invention with reference to the acenterpriseing drawings to such a degree that those skilled in the art implement the invention with ease.

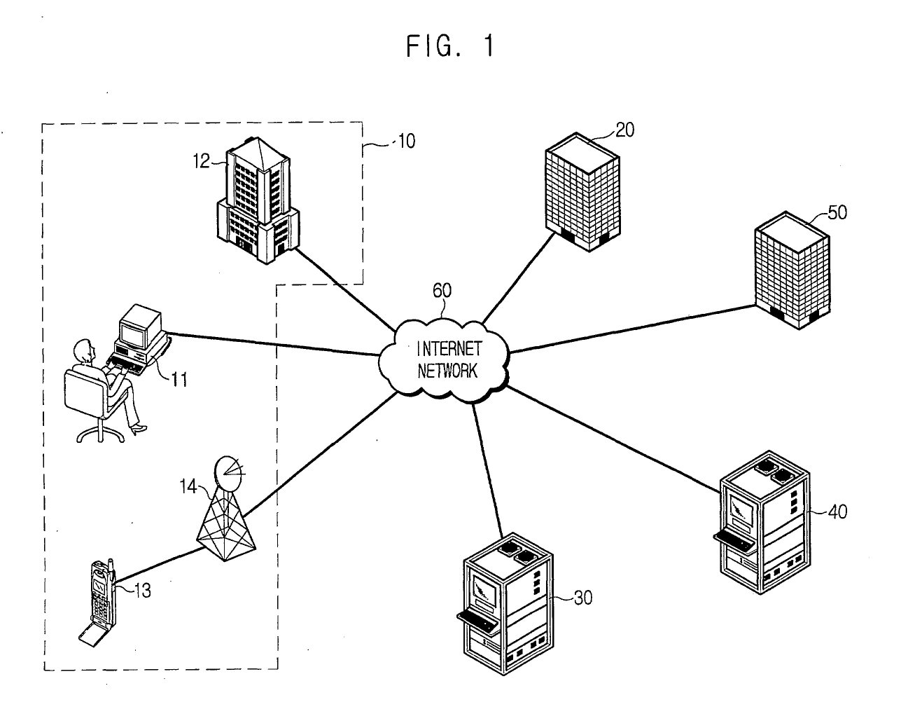

As shown in FIG. 1, a management system of an electronic receipt in accordance with is managed in the Internet environment, and a purchaser client 10, a sales server 20, a financial institution 30, an approval institution 40, and a product distributing company 50 are connected to the Internet network 60.

The purchaser client 10 includes wiring and wireless terminals who purchase a product at the sales server 20. In case of the wiring terminals 11 and 12, they are connected to the Internet network 60 through on-line, in case of the wireless terminal 13, it is connected to the Internet network 60 through a wireless relay 14. At this time, the wireless terminal 13 is defined to include a hand-held terminal, a PDA, an IMT-2000 hand-held terminal, etc. Here, the purchaser client 10 may be a person or a enterprise, in which a system used by the person is called “personal purchaser client”, and a system used by the enterprise is called “enterprise purchaser client”.

The sales server 20 manages an Internet shopping mall who sells product to the purchaser client 10, the financial institution 30 performs an approval on the payment information of the purchaser client 10 who purchases a product, the approval institution 40 issues a certification to prove the identification of the transaction parties who wish to perform an electronic commerce, and the product distributing company 50 delivers the product to the purchaser client 10 according to the order breakdown and purchase breakdown received from the sales server 20.

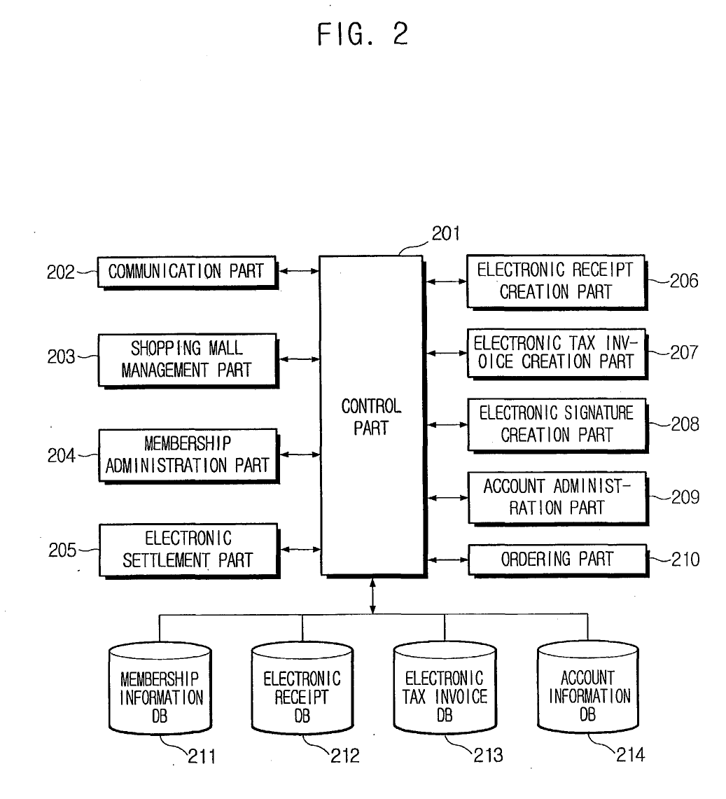

FIG. 2 is a block diagram schematically showing an inner constitution of the sales server 20. Referring to FIG. 2, a control part 201 generally controls respective elements of the sales server 20 such that the sales server 20 creates an electronic receipt containing a settlement breakdown information of a purchased product, and an electronic signature for confirming the sales server 20, encodes the created electronic receipt and electronic signature, transmits the encoded electronic receipt and electronic signature to the purchaser client 10, and matches the settlement breakdown information with an account information in one-to-one correspondence to manages the account information.

A communication part 202 is one that connects the sales server 20 with the Internet network 60. The communication part 202 receives a command or information input from the purchaser client 10 accessed to a homepage of the sales server 20, outputs pictures of the homepage of the sales server 20, or transmits a file including the electronic receipt and the electronic signature of a merchant to the purchaser client 10.

A shopping mall management part 203 manages a homepage on the website, and executes a providing of a product, and the electronic commerce. To realize this, the shopping mall management part 203 stores the product information displayed on the homepage in a database-adaptive data, and transmits the purchase breakdown and the order breakdown to the product distributing company depending on the purchase information of the product such that the product is delivered to the purchaser client 10.

A membership administration part 204 carries out functions such as a new membership of the purchaser client, a secession, a membership information change, etc., and confirms whether or not a purchaser client who tries the log in is the member or not.

Especially, the membership administration part 204 displays an input window of the member information, which includes a type (person, enterprise) item of the purchaser client 10, an identification item, an e-mail address item, etc. Here, in case that the purchaser client is the enterprise, the identification item preferably further contains a business registration number.

An electronic settlement part 205 requests an approval on the payment information of the purchaser client 10 to the financial institution 30, and determines whether or not the payment information is approved by the financial institution 30 and thereby an approval number is received.

An electronic receipt creation part 206 creates an electronic receipt containing the settlement breakdown information of the product purchased by the purchaser client 10, and stores the created electronic receipt at an electronic receipt database (DB) 212. Here, the settlement breakdown information of the product contains purchaser transaction information, seller transaction information, and product transaction information.

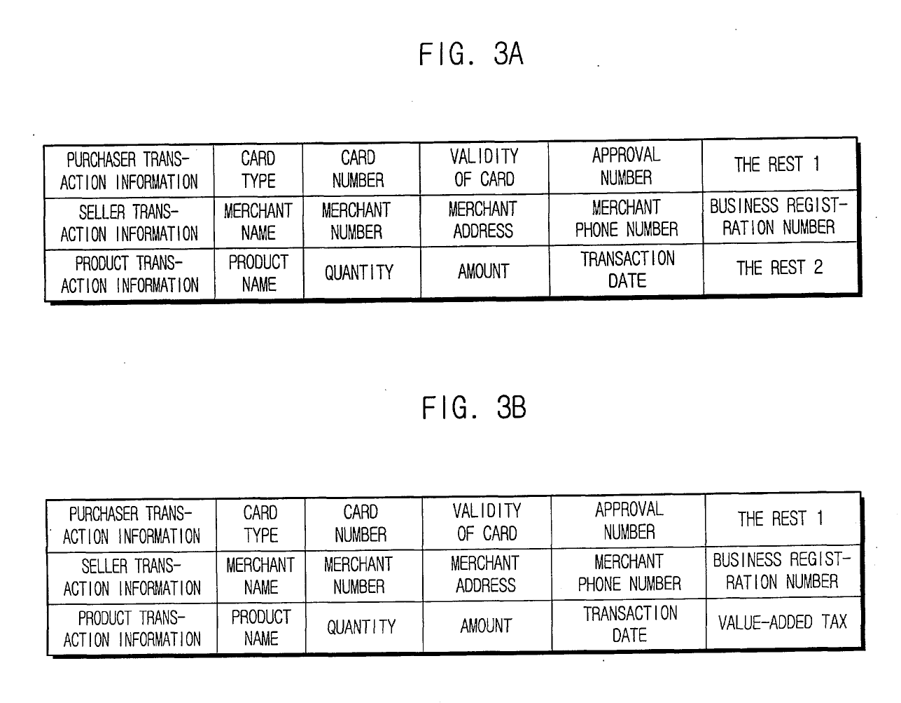

When the settlement breakdown information of the product contained in the electronic receipt is reviewed in more detail with reference to the accompanying FIG. 3, it is different depending on the purchaser client type, i.e., person or enterprise.

In other words, in case that the purchaser client 10 is the person, the settlement breakdown information of the product, as shown in FIG. 3A, includes: a purchaser transaction information containing a payment information and an approval number on the payment information, the payment information containing a card type, a card number, validity of card of the purchaser client, etc.; a seller transaction information containing a merchant name, a merchant address, a merchant phone number, and a merchant business registration number, etc.; and a product transaction information containing a purchased product name, a quantity, a price, a transaction date, etc.

Also, in case that the purchaser client 10 is the enterprise, the settlement breakdown information of the product, as shown in FIG. 3B, includes: a purchaser transaction information containing a payment information and an approval number on the payment information, the payment information containing a card type, a card number, validity of card of the purchaser client, a purchaser business registration number; a seller transaction information containing a merchant name, a merchant address, a merchant phone number, and a merchant business registration number; and a product transaction information containing a purchased product name, a quantity, a price, a transaction date, a value-added tax, etc.

An electronic tax invoice creation part 207 creates an electronic tax invoice based on the settlement breakdown information of the electronic receipt created in the electronic receipt creation part 206 upon an electronic commerce between the companies, and stores the created electronic tax invoice at an electronic tax invoice DB 213.

An electronic signature creation part 208 which an electronic signature creation key for creating an electronic signature is stored at, creates the electronic signature capable of confirming the sales server who sells the product, using the electronic signature creation key.

An account administration part 209 which an account program for performing an account processing such as income, expenditure, inventory, asset, balance, etc., is stored at, creates the account information by executing the account program and matching the product settlement breakdown information of the electronic receipt, created in the electronic receipt creation part 206 with an account item of the sales server in one-to-one correspondence, and stores the created account information at an account information DB 214.

An ordering part 210 transmits a product order breakdown and a product purchase breakdown on the order breakdown of the purchaser client 10 to the product distributing company 50 through the Internet network 60 according to a control of the shopping mall management part 203.

Meanwhile, the purchaser clients 10 who visit the homepage of the sales server 20 have different constitution depending on the purchaser types.

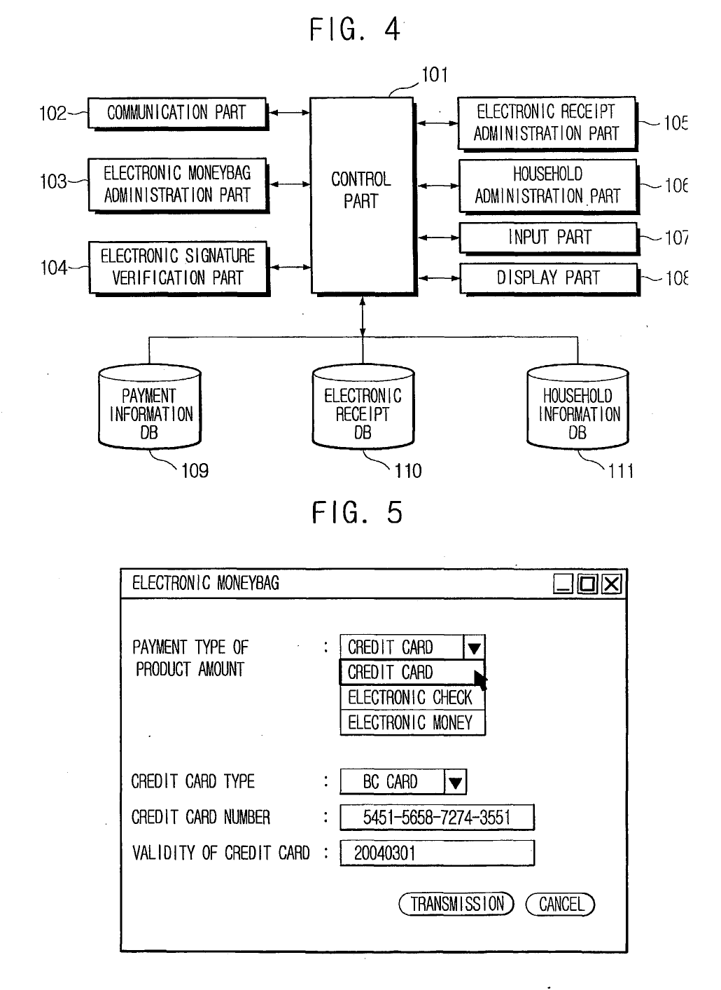

First, when reviewing an inner constitution of the personal purchaser client 11 referring to FIG. 4, a control part 101 generally controls the system, and in particular it transmits the payment information of the personal purchaser client to the sales server 20 in accordance with preferred embodiment of the present invention, and control respective parts such that the personal purchaser client can administrate the electronic receipt received from the sales server 20.

A communication part 102 is one that connects the personal purchaser client 10 with the Internet network 60. The communication part 102 transmits a payment information of the personal purchaser client 11, or receives an electronic receipt including the settlement breakdown information on a purchase product of the personal purchaser client 11, and an electronic signature capable of confirming the sales server 20 who has issued the electronic receipt.

An electronic moneybag administration part 103 which an electronic moneybag program which enables to display a picture allowing a registration of the payment information of the personal purchaser client 11 is stored at, stores the payment information of the personal purchaser client 11 at a payment information DB 109.

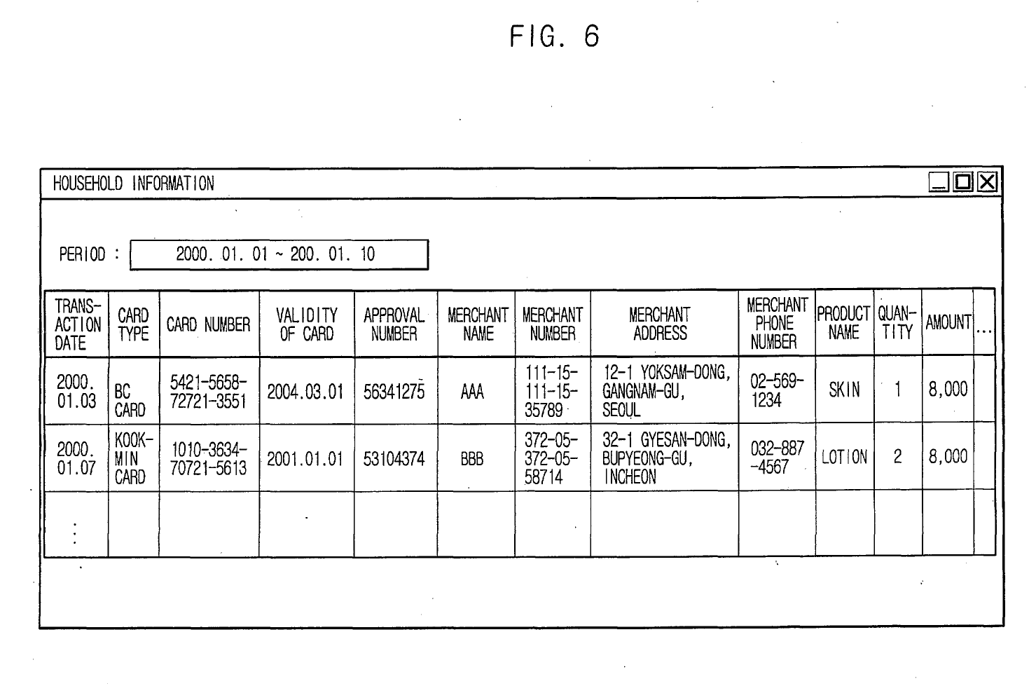

The personal purchaser client 11 downloads the electronic moneybag program from the homepage of the sales server 20 in order to perform the electronic commerce, and installs the electronic moneybag program as downloaded at the system of the personal purchaser client 11. The electronic moneybag administration part 103 executes the electronic moneybag program, provides a user interface to input the payment information of the personal purchaser client 11 as shown in FIG. 5, and stores the input payment information of the personal purchaser client 11 at the payment information DB 109.

For instance, in case that the personal purchaser client selects the credit card payment type out of the payment types, the electronic moneybag program requests to input detail information followed by the credit card payment, i.e., credit card type, credit card number, validity of credit card, etc.

An electronic signature verification part 104 stores an electronic signature verification program for confirming a seller of the purchased product, and an electronic signature verification key which is downloaded from the homepage of the sales server 20 before the personal purchaser client 11 carries out the electronic commerce therein.

In other words, as an encoded electronic signature is received from the sales server 20 together with the electronic receipt, the electronic signature verification part 104 executes the electronic signature verification program to decode the encoded electronic signature, and compares the decoded electronic signature with a previously stored electronic signature verification key to determine whether the received electronic signature is true or false.

An electronic receipt administration part 105 stores the electronic receipt which has been verified by the electronic signature verification part 104 in an electronic receipt DB 110.

A household administration part 106 stores therein a household program that is a program for creating a household information by matching the product settlement breakdown information on the electronic receipt stored in the electronic receipt DB 110 with a household item in one-to-one correspondence, and provides the personal purchaser client 11 with an arithmetic function to thereby enable to edit the household information, and stores the edited household information in a household information DB 111.

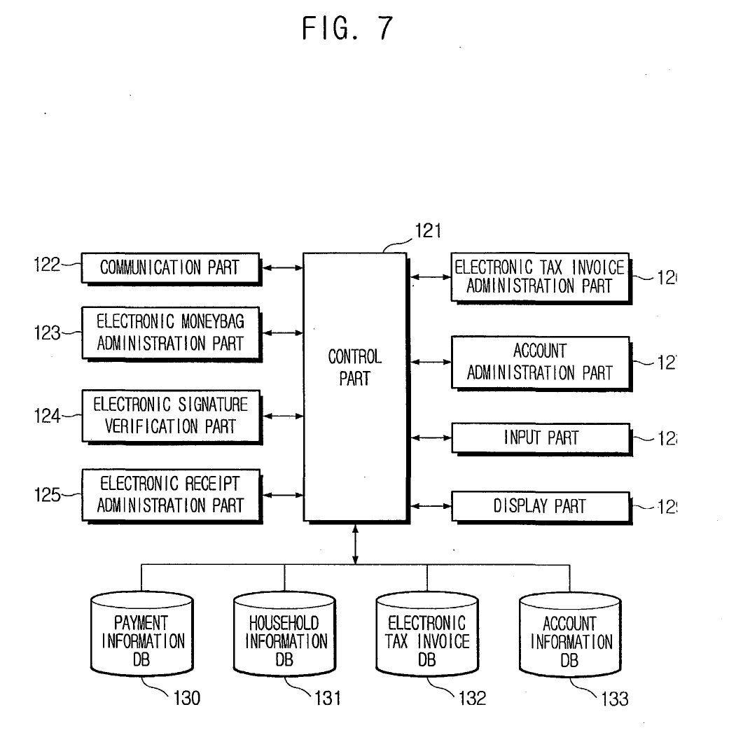

In other words, the household administration part 106 executes the household program stored therein to create the household information in which the product settlement breakdown information corresponds to the household items one-to-one as shown in FIG. 6, displays the created household information on a display part 108, and provides the arithmetic function for performing an edit work such as summing administration, sorting, etc., by date, enterprise name, and the like.

An input part 107 is one that the personal purchaser client inputs a variety of commands into the control part 101. The input part 107 inputs the payment information of the personal purchaser client, or the product transaction information, or edits the household information.

The display part 108 displays the user interface provided by the electronic moneybag administration part 103, the household information provided by the household administration part 106, or the electronic receipt provided by the electronic receipt administration part 105.

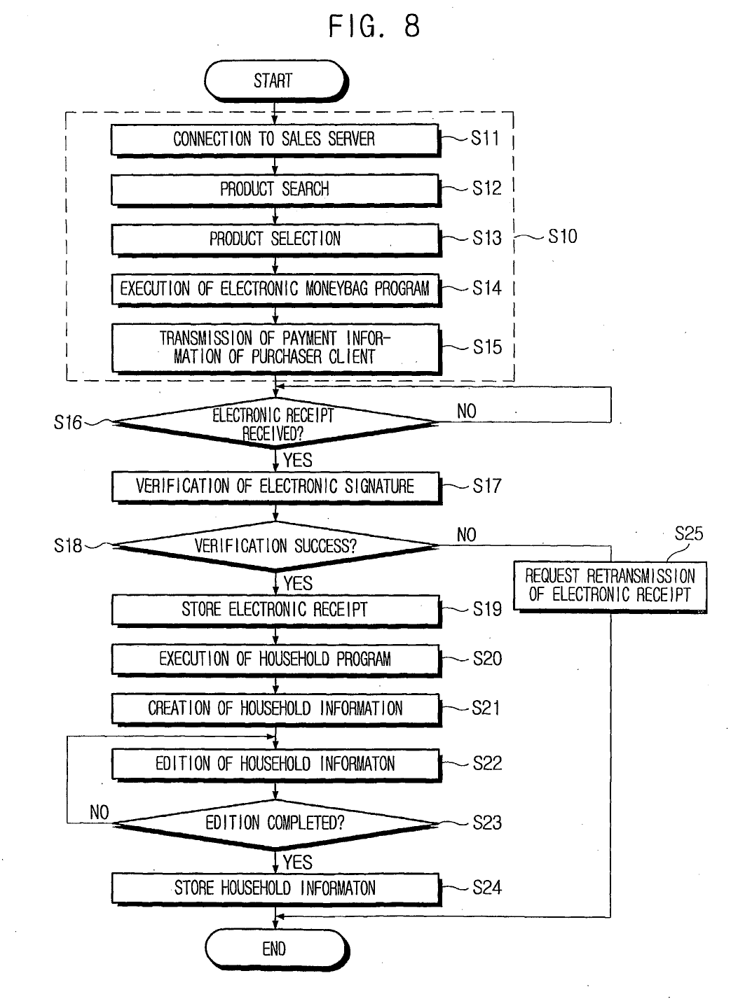

In the meanwhile, FIG. 7 shows an inner constitution of the enterprise purchaser client 12. For the convenience of description, there are described only elements that are different from those of the personal purchaser client shown in FIG. 4.

A control part 121 generally controls the enterprise purchaser client system, and in particular, it transmits the payment information of the enterprise purchaser client 12 to the sales server 20 according to preferred embodiment of the present invention, and controls respective elements of the system such that the enterprise purchaser client 12 can administrate the electronic receipt and electronic tax invoice received from the sales server 20.

An electronic tax invoice administration part 126 stores only the electronic tax invoice in which the electronic signature has been verified by the electronic signature verification part 124 out of the received electronic tax invoices.

An account administration part 127 stores therein an account program that is a program for executing an account processing such as income, expenditure, inventory, asset, balance, etc., and it executes the account program and matches the product settlement breakdown information of the electronic receipt, stored in an electronic receipt DB 131 with the account item in one-to-one correspondence to create the account information, and stores the created account information at an account information DB 133.

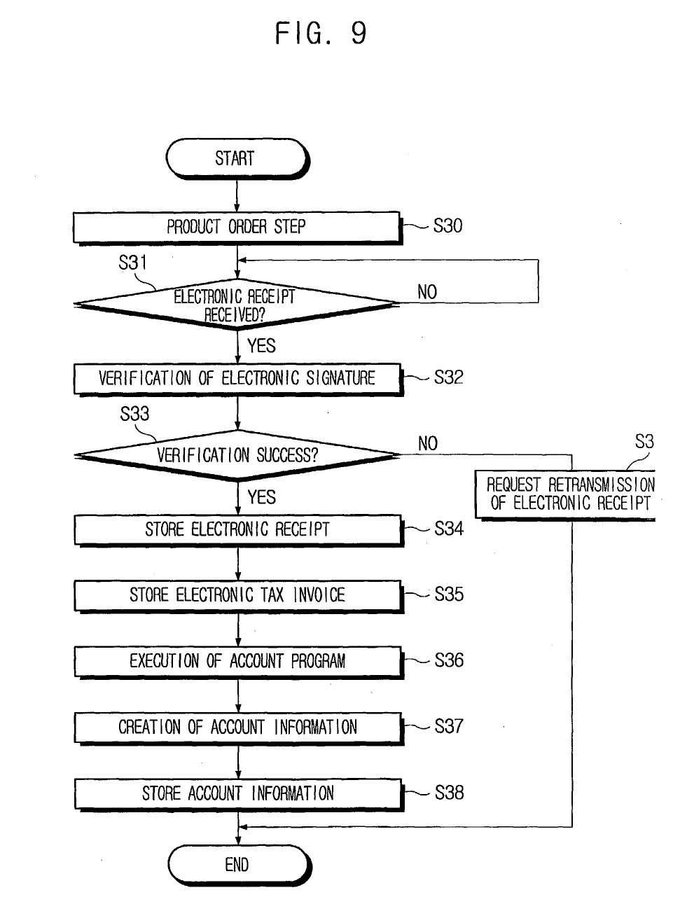

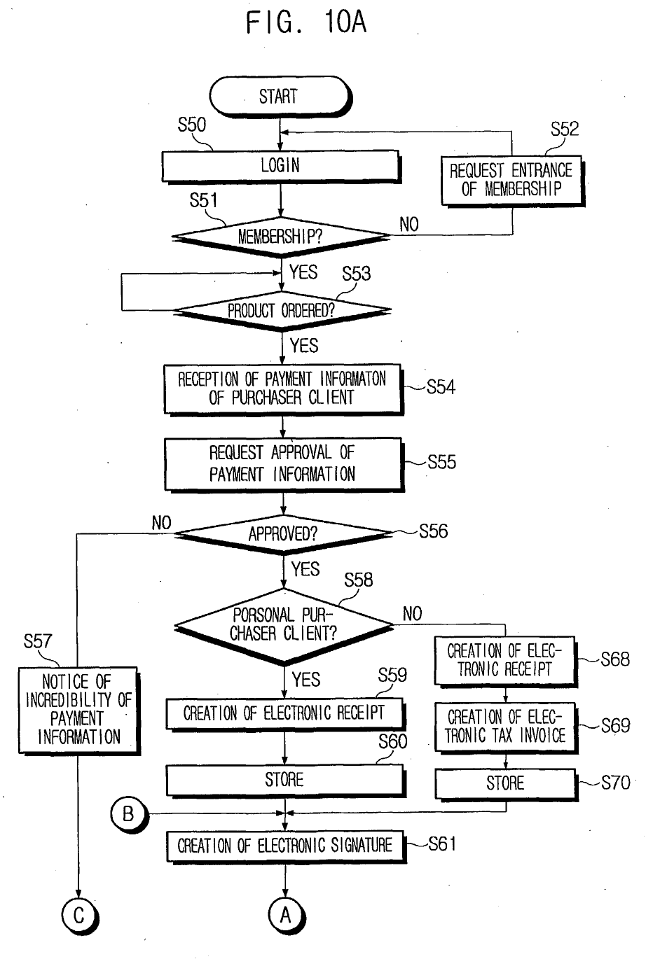

Operation of the present invention having the above constitution is described with reference to the accompanying drawings of FIG. 8 to FIG. 10.

For the convenience of description, a management method of an electronic receipt in the personal purchaser client 11 and the enterprise purchaser client 12, and a management method of an electronic receipt in the sales server 20 for selling a product are separately described.

First, in the execution of the management method of the electronic receipt by electronic commerce in accordance with the present invention, the purchaser client 10, the sales server 20, the financial institution 30, and the product distributing company 50 are issued with a certificate from the approval institution 40 in order to prove their identifications to the other party.

Also, the purchaser client 10 is downloaded the electronic moneybag program and the electronic signature verification key from the homepage of the sales server 20, and it executes the electronic moneybag program and inputs the payment information of the purchaser client 10.

Thus, the management method of the electronic receipt in accordance with the present invention should be carried out after an environment in which the system for managing the electronic receipt is operated is set.

<Management Method of Electronic Receipt in Personal Purchaser Client>

First, the personal purchaser client 11 carries out a product ordering step S10 in which the personal purchaser client 11 purchases a product through the homepage on the website managed by the sales server 20.

In other words, the control part 101 of the personal purchaser client 11 accesses to the sales server 20 through the communication part 102, searches products displayed on the homepage of the sales server 20 (S12), and selects a desired one out of the displayed products. (S13)

If the desired product is selected, the control part 101 of the personal purchaser client 11 executes the electronic moneybag program that is a web browser plug-in program through the electronic moneybag administration part 103 (S14), searches the payment information of the personal purchaser client 11, stored in the payment information DB 109, and transmits the searched payment information to the sales server 20 through the communication part 102. (S15) For instance, the payment information of the personal purchaser client contains credit card type, credit card number, and validity of credit card.

At this time, the electronic moneybag program requests to input a password when the purchaser client accesses to the payment information, and makes a scrambling the payment information using a block password algorithm such that only a specific purchaser client accesses to the payment information.

After transmitting the payment information of the personal purchaser client to the sales server 20, the control part 101 of the personal purchaser client 11 confirms whether or not a related file to the electronic receipt is received from the sales server through the communication part 102. (S116)

Here, the related file is directly transmitted to the personal purchaser client 11, or is transmitted to a corresponding mail address of the personal purchaser client 11. If the related file is directly transmitted to the personal purchaser client 11, the personal purchaser client 11 downloads the related file, while if the related file is transmitted to a corresponding mail address of the personal purchaser client 11, the personal purchaser client 11 executes an electronic mail program and downloads a corresponding file. At this time, the related file contains the electronic receipt and the electronic signature.

The control part 101 of the personal purchaser client 11 determines whether the sales server is true or false using the electronic signature received from the sales server 20 through the electronic signature verification part 104, and the previously stored electronic signature verification key. (S17) In other words, the electronic signature verification part 104 executes the electronic signature verification program, decodes the electronic signature which was encoded in the sales server 20 and received at the electronic signature verification part 104, and compares the decoded electronic signature with the previously stored electronic signature verification key.

As a result of the determination, if the electronic signature received from the sales server 20 is verified, i.e., the electronic signature received from the sales server 20 corresponds to the previously stored electronic signature verification key (S18), the control part 101 of the personal purchaser client 11 stores the electronic receipt received from the sales server 20 through the electronic receipt administration part 105 in the electronic receipt DB 110. (S19). At this time, the electronic receipt, as shown in FIG. 3A, contains the product settlement breakdown information.

Afterwards, the control part 101 of the personal purchaser client 11 executes the household program through the household administration part 106 (S20), and matches the product settlement breakdown information of the electronic receipt, stored in the electronic receipt DB 110 with the household items in one-to-one correspondence to create the household information as shown in FIG. 6. (S21) Here, the personal purchaser client 11 designates a period of the electronic receipt, thereby it is possible to create the household information included in a predetermined range.

The control part 101 of the personal purchaser client 11 displays the household information created through the household administration part 106 on a display part 108, and the personal purchaser client 11 arbitrarily edits the household information through the input part 107. For instance, the personal purchaser client 11 edits the household information using an arithmetic function such as administration of summing, sorting, etc., by date, company, etc.

As the edition of the household information is completed (S23), the control part 101 of the personal purchaser client 11 stores the household information edited through the household administration part 106 in the household information DB 111, and then completes all sequences.

Meanwhile, in the step S17 which determines whether the sales server 20 is true or false through the electronic signature verification part 104, if it is failed to verify the electronic signature received from the sales server 20, the control part 101 of the personal purchaser client 11 transmits to the sales server 20 a message which requests to retransmit the electronic receipt through the communication part 102.

<Management Method of Electronic Receipt in Enterprise Purchaser Client>

First, the enterprise purchaser client 12 carries out a product ordering step S30 in which the enterprise purchaser client 12 purchases a product through the homepage on the website managed by the sales server 20. However, since the sequence is identical to the step S10 shown in FIG. 8, its description is omitted.

After the product ordering step S30 has been carried out, the control part 121 of the enterprise purchaser client 12 confirms whether or not a related file to the electronic receipt is received from the sales server 20. (S31) Here, the related file received from the sales server 20 contains the electronic receipt, the electronic tax invoice, and the electronic signature.

The control part 121 of the enterprise purchaser client 12 confirms whether the sales server is true or false using the electronic signature received from the sales server 20 through the electronic signature verification part 124, and the previously stored electronic signature verification key. (S32)

As a result of the confirmation, if the electronic signature received from the sales server 20 is verified, (S33) the control part 121 of the enterprise purchaser client 12 stores the electronic receipt received from the sales server 20 through the electronic receipt administration part 125 in the electronic receipt DB 131. (S34) At this time, the electronic receipt, as shown in FIG. 3B, contains the product settlement breakdown information.

Also, the control part 121 of the enterprise purchaser client 12 stores the electronic tax invoice received from the sales server 20 through the electronic tax invoice administration part 126 in the electronic tax invoice DB 132 (S35), which is to use the stored electronic tax invoice when the enterprise purchaser client makes a declaration of the purchaser's income at a government authority such as the office of national tax administration, etc.

If the electronic receipt and electronic tax invoice received from the sales server 20 are stored in the respective DB 131 and 132, the control part 121 of the enterprise purchaser client 12 executes the account program through the account administration part 127 (S36), and creates an account information in which the product settlement breakdown information of the electronic receipt, stored in the electronic receipt DB 131 corresponds to the household items one-to-one. (S37)

For instance, in case that the enterprise purchaser client 12 purchases two printers at a price of 350,000 won through the sales server 20, the enterprises purchaser client 12 fills in 700,000 won on an expenditure item of the account item, and in two printers on an asset item of the account item, thereby decreasing the balance item by the expenditure amount, and increasing the income item by the purchased products.

Thus, if the account information in which the product settlement breakdown information corresponds to the account item one-to-one is created, the control part 121 of the enterprise purchaser client 12 controls the display part 129 to displays the created account information so that the enterprise purchaser client 12 can confirm the created account information. Afterwards, the control part 121 of the enterprise purchaser client 12 stores the created account information in the account information DB 133 (S38), and then ends all of the sequences.

Meanwhile, in the step S32 which determines whether the sales server 20 is true or false through the electronic signature verification part 124, if it is failed to verify the electronic signature received from the sales server 20, the control part 121 of the enterprise purchaser client 12 transmits to the sales server 20 a message which requests to retransmit the electronic receipt through the communication part 122. (S39)

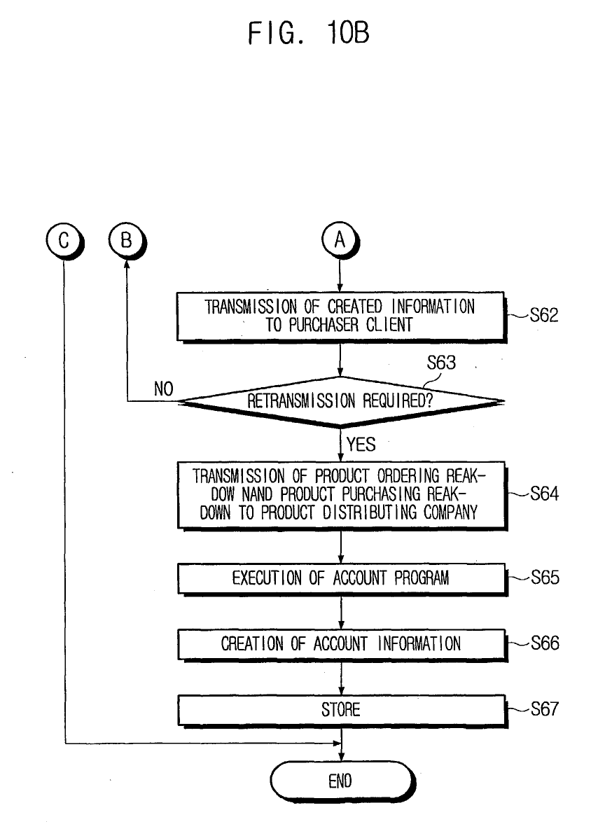

FIG. 10 is a flow chart showing a management sequence of the electronic receipt in the sales server who sells a product to the enterprise purchaser client or the personal purchaser client.

Referring to FIG. 10, as the purchaser client 10 performs login (S50), the control part 201 of the sales server 20 confirms whether or not input ID and password of the purchaser client 10 correspond to the membership information stored in the membership information DB 211 through the membership administration part. (S51) Here, if the purchaser client 10 who performs the login does not have the membership, the purchaser client 10 requests the membership. (S52)

If the purchaser client 10 has the membership, the control part 201 of the sales server 20 confirms whether there exists a product order through the shopping mall management part 203 (S53), and receives the transaction information of a product selected by the purchaser client 10 and the payment information transmitted from the purchaser client 10. (S54)

The control part 201 of the sales server 20 stores the transaction information of the product through the shopping mall management part 203, and manages the stored transaction information of the product, transmits the payment information (for example, card number) of the purchaser client to the financial institution 30 through the electronic settlement part 205, and request an approval (S55), and confirms whether or not the payment information of the purchaser client 10 is approved, and an approval number is received. (S56) Here, if the payment information of the purchaser client 10 is not approved, the control part 201 of the sales server 20 transmits an error message indicative of defective payment information to the purchaser client 10 (S57), and ends all of the sequences.

If the payment information is approved, the control part 201 of the sales server 20 confirms whether the purchaser client is individual or enterprise with reference to the membership information stored in the membership information DB 211 through the membership management part 204. (S58) This is for issuing the electronic tax invoice, and the sales server 20 checks whether or not the business registration number is included in the membership information of the purchaser client stored in the membership information DB 211, and confirms the purchaser client type.

As a consequence of the confirmation, if the purchaser client is the individual purchaser client, the control part 201 of the sales server 20 creates the electronic receipt containing the product settlement breakdown information (S59), and stores the created electronic receipt in the electronic receipt DB 212. (S60) Here, as shown in FIG. 3A, the product settlement breakdown information contains the purchaser transaction information, the seller transaction information and the product transaction information. At this time, the purchaser transaction information contains the payment information transmitted from the personal purchaser client 11, and the approval number received from the financial institution 30.

If the electronic receipt is created, the control part 201 of the sales server 20 creates the electronic signature for confirming the sales server using the electronic signature creation key through the electronic signature creation part 208. (S61)

Thus, if the electronic receipt and the electronic signature are created, the control part 201 of the sales server 20 transmits the created electronic receipt together with the encoded electronic signature to the purchaser client 10 through the communication part 202. (S62)

After that, the control part 201 of the sales server 20 confirms whether retransmission request of the electronic receipt is received from the purchaser client 10 through the communication part 202. (S63) Here, the purchaser client's retransmission request of the electronic receipt corresponds to a case that the electronic signature to which the sales server transmits does not correspond to the previously stored electronic signature verification key.

As a consequence of the confirmation, if retransmission of the electronic receipt is requested, the control part 201 of the sales server 20 returns to the step S61 of creating the electronic signature. If the retransmission of the electronic receipt is not requested, the control part 201 of the sales server 20 transmits the product order breakdown and the product purchase breakdown requested by the purchaser client to the product distributing company through the ordering part 210. (S64)

If the delivery on the product purchase requested by the purchaser client is completed, the control part 201 of the sales server 20 executes the account program through the account administration part 209 (S65), creates an account information in which the product settlement breakdown information stored in the electronic receipt DB 212 corresponds to the account item (S66), and stores the created account information in the account information DB 214. (S67)

For instance, in case that the purchaser client 10 purchases two printers at a price of 350,000 won through the sales server 20, the sales server 20 fills in 700,000 won on an income item of the account item, and in two printers on an inventory item of the account item, thereby increasing the balance item by the income amount, and decreasing the inventory item by the purchased products.

Meanwhile, in the step S58 which confirms the purchaser client, if it is confirmed that the purchaser client is the enterprise purchaser client, the control part 201 of the sales server 20 creates the electronic receipt containing the product settlement breakdown information through the electronic receipt creation part 206 (S68), creates the electronic tax invoice through the electronic tax invoice creation part 207 with reference to the product settlement breakdown information of the electronic receipt (S69), and stores the created electronic receipt and the created electronic tax invoice in the respective databases 212 and 213. (S70)

Here, the product settlement breakdown information of the electronic receipt stored in the electronic receipt DB 212, as shown in FIG. 3B, contains the purchaser transaction information, the seller transaction information, and the product transaction information. At this time, the purchaser transaction information contains the payment information transmitted from the enterprise purchaser client 12, and the approval number received from the financial institution 30, and the product transaction information contains the product transaction breakdown and the value-added tax obtained to correspond to the product price.

After creating and storing the electronic receipt and the electronic tax invoice, the control part 201 of the sales server 20 moves to the step S61 and creates the electronic signature for confirming the sales server 20.

### INDUSTRIAL APPLICABILITY

As described previously, the management method of electronic receipts by an electronic commerce in accordance with the present invention has the following advantages.

First, an electronic receipt containing the settlement breakdown information of a product, and an electronic tax invoice are issued in real time together with an occurrence of an electronic commerce, and thereby the transparency and stability of the electronic commerce are enhanced.

Also, when B2B is carried out, the electronic tax invoice issued by the sales server can be provided to a government authority such as the office of national tax administration performing taxation, tax deduction, and levy depending on enterprise activities as well as to the enterprise purchaser client. If so, the office of national tax administration can easily confirm the taxation data between the sales server and the enterprise purchaser client, and the sales server and there is no need that the enterprise purchaser client make a declaration of the purchaser client's income separately.

Further, purchaser clients with wireless terminals confirms the breakdown of the electronic receipt transmitted from the sales server, and then can transmit the breakdown to their e-mail addresses.

Furthermore, personal purchaser clients can easily confirm the settlement breakdown information of a product purchased through the electronic commerce, and can edit and manage a household information obtained by one-to-one correspondence of the settlement breakdown information of the products.

Moreover, the enterprise purchaser client or the sales server can keep and manage the account information obtained by one-to-one correspondence of the settlement breakdown information of the products.

This invention has been described above with reference to the aforementioned embodiments. It is evident, however, that many alternative modifications and variations will be apparent to those having skills in the art in light of the foregoing description. Accordingly, the present invention embraces all such alternative modifications and variations as fall within the spirit and scope of the appended claims.

1. (amended) A management system of an electronic receipt, the system being applied to an electronic commerce system in which a plurality of purchaser clients for purchasing a product, and meet a payment on the purchase product, a sales server for selling the product to the purchaser clients, a financial institution for carrying out an approval on a payment information of the purchaser clients, and a product distributing company for delivering the product to the purchaser clients, are connected to each other through an Internet network,
wherein the sales server issues the electronic receipt containing a settlement breakdown information of the purchase product, and compares the settlement breakdown information with an account item in one-to-one correspondence to create an account information and store, and to keep and manage the created account information, and in case that the purchaser client is the enterprise, an electric tax invoice is created based on the settlement breakdown information, and
the purchaser clients transmit the payment information to the sales server, store the electronic receipt transmitted from the sales server, and keep and manage the settlement breakdown information of the product.

2. The management system of claim 1, wherein the sales server comprises:
a shopping mall management part for managing and administrating a homepage of providing information on the product, and realizing a providing of the product and the electronic commerce;
a membership administration part for administrating a membership of the purchaser clients, a secession, and a member information change, and confirming types of the purchaser clients;
an electronic settlement part for requesting an approval on the payment information of the purchaser clients who purchase the product to the financial institution;
an electronic receipt creation part for creating the electronic receipt containing the settlement breakdown information on the purchasing product if the payment information is approved;
an electronic signature creation part for creating an electronic signature of the sales server using an electronic signature creating key;
an account administration part for creating the account information by comparing the settlement breakdown information of the product with the account item of the sales server in one-to-one correspondence; and
a control part for generally controlling all of the parts such that the created electronic receipt and the electronic signature are transmitted to the purchaser clients.

3. The management system of claim 2, wherein the sales server further comprises an electronic tax invoice creation part for creating an electronic tax invoice based on the settlement breakdown information of the product, and if the purchaser client is an enterprise, the control part computes a value-added tax corresponding to a price of the product, creates the electronic receipt and the electronic tax invoice, and transmits the created electronic receipt and the electronic tax invoice to the purchaser client.

4. The management system of claim 1, wherein the purchaser client comprises:
an electronic moneybag administration part for storing the payment information for meeting the payment on the product;
an electronic signature verification part for storing an electronic signature verification key of the sales server, and confirming whether the electronic receipt transmitted from the sales server is true or false;
an electronic receipt administration part for storing the electronic receipt which has been verified by the electronic signature verification part;
a household administration part for creating a household information by comparing the settlement breakdown information of the product with a household item of the purchaser client in one-to-one correspondence, and for providing an edit function for editing and managing the household information; and
a control part for generally controlling all of the parts.

5. The management system of claim 3 or 4, wherein the settlement breakdown information of the product comprises:
a purchaser transaction information including a payment information and an approval number on the payment information, the payment information including a card type, a card number, a validity of card of the purchaser client;
a seller transaction information including a merchant name, a merchant address a merchant phone number, and a merchant business registration number; and
a product transaction information including a purchased product name a quantity, a price, and a transaction date.

6. The management system of claim 1, wherein the purchaser client comprises:
an electronic moneybag administration part for storing the payment information for meeting the payment on the product;
an electronic signature verification part for storing an electronic signature verification key of the sales server, and confirming whether the electronic receipt transmitted from the sales server is true or false;
an electronic receipt management part for storing the electronic receipt which has been verified by the electronic signature verification part;
an electronic tax invoice management part for storing the electronic tax invoice which has been verified by the electronic signature verification part;
an account management part for creating the account information by comparing the settlement breakdown information of the product with the account item of the purchaser client in one-to-one correspondence, and managing the created account information; and
a control part for generally controlling all of the parts.

7. The management system of claim 3 or 6, wherein the settlement breakdown information comprises:
a purchaser transaction information including a payment information and an approval number on the payment information, the payment information including a card type, a card number, a validity of card, and a merchant registration number of the purchaser client;
a seller transaction information including a provider name, an address, a phone number, and a provider registration number; and
a product transaction information including a purchased product name, a quantity, a price, a transaction date, and a value-added tax.

8. A management method of an electronic receipt, the method comprising:
a product ordering step in which a purchaser client connected to an Internet searches a product information, orders a product, and inputs a payment information for meeting the payment on the ordered product;
an electronic receipt issuing step in which a sales server who manages a homepage creates an electronic receipt containing a settlement breakdown information of the product ordered by the purchaser client, and an electronic signature for confirming a seller of the sales server, and transmits the created electronic receipt and electronic signature to the purchaser client;
an account information creating step in which the sales server compares a product settlement breakdown information of the electronic receipt with an account item in one-to-one correspondence to create an account information;
an electronic receipt storing step in which the purchaser client stores the product settlement breakdown information of the electronic receipt transmitted from the sales server; and
a product settlement breakdown managing step in which the purchaser client keeps and manages the stored product settlement breakdown information of the electronic receipt.

9. The method of claim 8, further comprising an electronic signature determining step in which the purchaser client determines whether an electronic signature is true or false by using the electronic signature created by sales server issuing the electronic receipt and a previously stored electronic signature verification key of the sales server, if the electronic signature is approved, the electronic receipt storing step is performed.

10. The method of claim 8, wherein the sales server further comprises a step of confirming a kind of the purchaser client who has performed the product ordering step, and if the purchaser client is a enterprise, the sales server creates an electronic tax invoice based on the product settlement breakdown information at the electronic receipt issuing step, and transmits the created electronic tax invoice together with the electronic receipt and the electronic signature to the purchaser client.

11. The method of claim 8, wherein the product settlement breakdown managing step comprises a step in which the purchaser client compares the settlement breakdown information transmitted from the sales server with a household item of the purchaser client in one-to-one correspondence to create a household information, and edits and manages the created household information.

12. The method of claim 8, wherein the product settlement breakdown managing step comprises a step in which the purchaser client compares the settlement breakdown information transmitted from the sales server with an account item of the purchaser client in one-to-one correspondence to create an account information, and stores and manages the created account information.

13. The method of claim 8, wherein the electronic receipt issuing step comprises a step of encoding the electronic receipt and the electronic signature and transmits the encoded electronic receipt and electronic signature to an electronic mail address of the purchaser client.
